(19) United States
(12) Patent Application Publication
(10) Pub. No.: US 2006/0218410 A1
(43) Pub. Date: Sep. 28, 2006

(54) Method and system to announce or prevent voyeur recording in a monitored environment

(76) Inventors: Arnaud Robert, Burbank, CA (US); Robert Harry Heath, San Francisco, CA (US)

Correspondence Address: THOMSON LICENSING INC., PATENT OPERATIONS, PO BOX 5312, PRINCETON, NJ, 08543-5312, US

(21) Appl. No.: 11/346,026

(22) Filed: Feb. 2, 2006

Related U.S. Application Data
(60) Provisional application No. 60/653,172, filed on Feb. 15, 2005.

(51) Int. Cl. G06F 12/14

(52) U.S. Cl. 713/189

(57) ABSTRACT

To address the problem of unauthorized recording by one or more recording devices (200), a monitoring system (100) monitors an environment (300). The monitoring can include the broadcast by the monitoring system of a recording device restriction signal to alert each recording device of a recording restriction within the monitored signal. Alternatively the monitoring system upon detecting a recording presence signal transmitted by a recording device to indicate its presence, can broadcast a warning signal and/or a recording device disable signal to inhibit device recording.

### CROSS-REFERENCE TO RELATED APPLICATIONS

This application claims priority under 35 U.S.C. 119(e) to U.S. Provisional Patent Application Ser. No. 60/653,172 filed Feb. 15, 2004, the teachings of which are incorporated herein.

### FIELD OF THE INVENTION

This invention relates to a technique for preventing unauthorized recording.

### BACKGROUND OF THE INVENTION

Electronic voyeurism, as used herein constitutes the act of making an unauthorized recording of a subject (i.e., a victim) by a person (i.e., a “voyeur”). Such unauthorized recording by the voyeur can comprise the recording of audio, video, audio-video, or even the taking of a still picture by means of a recording device. Such recording devices can take any form, such as a cellular camera phone, a personal data assistance (PDA), or other types of devices, wireless or otherwise, that possess the ability to record audio and/or video and/or to capture still images. Thus, for purposes of discussion, image capture devices such as digital cameras constitute recording devices. As electronic recording devices have become smaller in size, the ability of a victim to detect surreptitious recording by such devices has become commensurately more difficult. Many jurisdictions have laws and regulations that afford individuals a zone of privacy, even in a public space. In addition, many jurisdictions afford individuals an exclusive right to their image. Surreptitious recording of victims and the subsequent publication of such recordings can not only subject such victims to unwanted publicity or embarrassment, but can also constitute a breach of the victims' right to privacy.

As an example of such an unauthorized surreptitious recording, consider a voyeur who uses a mobile phone with integrated high resolution camera and high quality microphone, in a semi-public environment, such as a locker room, public rest-room, or a sauna, to record images of the victim in a state of undress. Unwanted publication such images could expose the victim to significant embarrassment for which no amount of economic recovery could compensate.

Within the prior art, several proposals exist to inhibit unauthorized use of electronic recording devices. One suggested approach relies upon the introduction of “nuisance signals” which interact in specific ways with the recording device. One approach utilized to interfere with undesired mobile or cellular communications, and in particular, unauthorized recording, relies on the broadcast of a nuisance signal (in this case, radio frequency noise in the cellular frequency range) that will jam the cellular device and alter the quality of the useful signal received thereby, which will not always affect recording.

This approach does not rely on the presence of the recording device, and thus constitutes a passive approach because of continuous transmission of the jamming signal. Moreover, this approach generally defeats all useful signaling within the targeted frequency range, including any signaling during an emergency. Moreover, generating such nuisance signals typically require license from the appropriate governmental authority depending on the signal strength. In addition, this approach does not serve to defeat unauthorized or audio recording or photography because any nuisance signal needed to interfere with such recording would likely fall within the ranges of human hearing and vision, respectively, and be considered objectionable by most individuals.

Another approach to restricting unauthorized recording involves altering a displayed video image in such a way that the interaction of the altered video image and the recording device yields a recording of unacceptable quality. This approach serves as the basis for many of the camcorder-defeat technologies for prohibiting unauthorized recording of theatrical film. With many of the camcorder-defeat technologies, the displayed image contains distortions introduced in such a way that they appear generally imperceptible to humans but they deteriorate the quality of a recording by introducing nuisance signals detected by the camcorder.

The above-described approaches require selection of a nuisance signal in accordance with the specific characteristics of the recording device. Thus, such approaches degrade the user experience. However, because the degradation strategy depends upon the characteristics of the recording device, modifications to the recording device can negate the presence of the nuisance signal. For example, the use of visible or electronic filters which detect and correct for the nuisance signal could allow recording of an acceptable copy despite the presence of the nuisance signal. Moreover, the above-described approach does not operate in response to the actual presence of an unwanted recording device.

More recently, a system has been proposed which enables the recording device to operate in response to attention clues from a potential victim indicative of whether or not he or she authorizes recording. For example, if the recording device detects a smile or other favorable expression from the victim signifying consent to the recording, the device would allow recording by the voyeur at that moment. The operation of such recording devices relies on a challenging hypothesis; namely that algorithms exist which possess the necessary sophistication to interpret human clues that signally consent to recording. Further, the voyeur could easily defeat this approach by waiting for any attention clues to disappear that prevent recording.

A number of other systems have been proposed to alter the recording devices in such a way to prevent recording of a victim's private information. One approach requires the victim carry a transmitter that broadcasts a signal to alert a recording device that the victim does not consent to being recorded or photographed. The detection of such signal by the recording device triggers algorithms that render unrecognizable critical body parts of the victim such as the face. This proposed approach suffers from the limitation that the victim must wear some kind of transmitter to prevent recording.

A variant of the previous approach enables the victim to signal his or her willingness to be photographed by transmitting a first signal (i.e., a “photograph” signal) which would enable any recording device to record the victim. Alternatively, if the victim chooses not to be photographed, the victim would transmit a second signal (i.e., a “paparazzi” signal) which would prevent the recording device from recording. This approach incurs a number of difficulties. First, the victim must carry a compliant transmitter, and must remember to set the transmitter in the proper transmission mode (“photograph” or “paparazzi”). Second, in the event that two victims come into proximity with each other and appear as one in the field of capture of the voyeur's recording device, the voyeur could make a recording as long as one of the two victims broadcasts a “photograph” signal, despite the “paparazzi” signal broadcast by the other victim. Third, the presence of a victim broadcasting a “paparazzi” signal could impede the voyeur from operating his or her recording device in a legitimate manner.

A variant of the above-described approach proposes to automatically detect “hot spots” in an image, such as a victim's face, upon activation of the zoom function of a visual recording device, such as a camcorder or digital still camera. The image of tie victim's face then undergoes automatic darkening by the recording device using simple pixel manipulation. This approach incurs certain limitations. First, this approach impairs taking the picture of some one who willingly wants his or her picture taken. Second, a voyeur can easily defeat this technique by making sure the victim's image appears out of locus. Under such conditions, the recording device probably would lack the ability to detect the victim's face, thereby avoiding pixel darkening. After taking the picture, the voyeur could make use commonly available photo software to reconstitute the crispness of the victim's face.

Thus, a need exists for a technique that provides a victim with protection against unauthorized recording, and enables any institution hosting the potential victim to reliably assert that potential victims enjoy protection against unauthorized recording. In other words, a need exists for a technique can detect the presence of a voyeur's recording device and to alert the victim or the institution hosting the victim accordingly, and/or to prevent the voyeur's recording device from recording.

### SUMMARY OF THE INVENTION

Briefly, in accordance with a first aspect of the present principles, there is provided a method for communicating recording restrictions to a recording device. The method comprises the step of broadcasting, within a defined environment a recording device restriction signal for reception by a recording device. The broadcasted signal serves to alert the recording device of one or more recording restrictions in the defined environment.

In accordance with another aspect of the invention, there is provided a method for alerting a monitoring system of the presence of at least one recording device in a monitored environment. The method comprises the step of broadcasting from the recording device a recording device presence signal that alerts monitoring system of the presence of the recording device.

In accordance with yet another aspect of the present principles, the presence of a recording device within the monitored environment, as detected by a monitoring system can trigger one or more responses. For example, upon detecting the presence of recording device presence signal from at least one device in the monitored environment, the monitoring system broadcast an alert, typically in the form or either an aural and/or visual signal, to alert potential victims of the presence of such recording devices. In addition to, or in place of generating a warning signal, the monitoring system could generate a recording device inhibit signal, which, upon receipt of the recording device, would inhibit recording.

### BRIEF SUMMARY OF THE DRAWINGS

FIG. 1 depicts a block schematic of a monitoring system for detecting the presence of a recording devices in a monitored environment in accordance with a first aspect of the present principles;

FIG. 2 depicts a block schematic diagram of a monitoring system for communicating with a recording device in a monitored environment for announcing and/or preventing unauthorized recording in accordance with a second aspect of the present, principles;

FIG. 3 depicts a block schematic diagram of a monitoring system for communicating with a recording device in a monitored environment for preventing unauthorized recording in accordance with a third aspect of the present principles; and

FIG. 4 depicts a block schematic diagram of a monitoring system for communicating with a recording device in a monitored environment for preventing unauthorized recording in accordance with a fourth aspect of the present principles.

### DETAILED DISCUSSION

In accordance with the present principles, the use of a monitoring system serves to address the problem of unauthorized recording of a victim by an electronic voyeur. The monitoring system can broadcast a recording device restriction signal alert to a recording device of recording restrictions. In place of or in addition to broadcasting a recording device restriction signal, the monitoring system can broadcast a recording device disable signal that will inhibit a recording device from recording. In place of, or in addition to, either alerting and/or disabling a recording device, the monitoring system can detect the presence of a recording device and generate a warning to potential victims who do not want to be recorded.

FIG. 1 depicts a block schematic diagram of a monitoring system 100 in accordance with a first aspect of the present principles. The monitoring system (100) comprises at least a transmitter or similar mechanism capable of broadcasting an alert, in the form of a recording, device restriction signal, to one or more “receive-complaint” recording devices, illustratively depicted by devices 200₁, 200₂ and 200₃, within a monitored environment 300. The term “receive-compliant,” as used in the context of FIG. 1, refers to a recording device having the capability of receiving the recording device restriction signal from the monitoring system 100 indicative of one or more recording restrictions within the monitored environment 300.

Typically, although not necessarily, receive-compliant recording devices will possess an indicator for providing a visual or sensory indication of a recording restriction that exists within the monitored environment 100. For example, a receive-compliant recording device could include a light or other type of for indicating receipt of a recording device restriction signal. A receive-compliant recording device could generate an auditory signal or generate a vibration to indicate receipt of a recording device restriction signal. Receive-compliant recording devices can include, but are not limited to, cellular telephones with cameras and/or audio microphones, personal data assistant (PDA) devices with audio and/or video capture capability, audio: recorders, video recorders, digital still cameras and the like.

In response to the recording device restriction signal broadcast by the monitoring system 100 of FIG. 1, each of the receive-compliant recording devices 200₁-200₃ inhibit its recording operation. A receive complaint recording device, such as receive-compliant recording device 200₄ that lies outside the monitored environment (300) presumably will not receive the recording device predefined signal from the monitoring system.

The recording device restriction signal transmitted by the monitoring system 100 to indicate recording restrictions can comprise an auditory signal, a visible light, an invisible light (e.g., infrared light), a radio-frequency signal, a wireless signal, and/or any 25 combination of such signals. As a general rule, radio frequency or wireless signals likely will prove most versatile because auditory and visible light signals lie within the range of human perception and likely will not prove generally acceptable. Moreover, the transmission of auditory and light signals from a recording device can cause interference, and “shadow” deficiencies as compared to transmitting radio-frequency and wireless signals.

The recording device restriction signal could have different characteristics to indicate different recording restrictions. For example, the recording device restriction signal could indicate to a receive-compliant recording device of the existence of restriction against all recording. A recording device restriction signal with different characteristics could indicate a restriction against video and still image capture, but no restriction against audio recording.

Upon receipt of the recording device restriction signal from the monitoring system 100, each of the recording devices could have the obligation to acknowledge receipt of such a signal by way of an audio signal, a visual signal, an audio visual signal, a radio frequency or wireless signal, or any combination of the above. Such an acknowledgement signal would indicate that some or all the recording capabilities of the compliant recording device no longer remain operative. Note that receipt of the acknowledgement signal by the monitoring system 100 does not constitute all essential feature of the present principles. However, receipt of an acknowledgement from a particular recording device at the monitoring system 100 could constitute legal proof that the recording device sought to comply with the recording restrictions then in existence within the monitored environment 300.

Rather than simply send an acknowledgement signal, each recording device of FIG. 1 could exchange meaningful messages with the monitoring system 100. Such signals, sent by radio-frequency, wireless, or cellular signals or otherwise, would allow the identification or exposition of the characteristics of the recording device, as well as the restriction(s), if any, imposed by the monitoring system 100 at that time. This would allow the recording device to perform only a subset of its recording capabilities. By exchanging messages with the monitoring system 100 of FIG. 1, each recording device could receive signals from the monitoring system specific to its location.

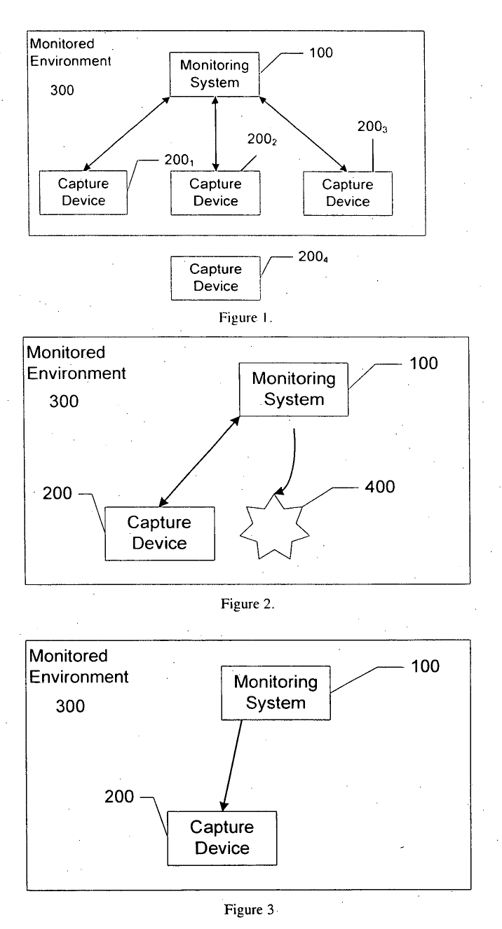

FIG. 2 depicts a block schematic diagram of a second embodiment of a monitoring system 100 for detecting the presence of at least one transmit-compliant recording device 200 in the monitored environment 300. For the purposes of the embodiment of FIG. 2, a transmit-compliant recording device, such as device 200, broadcasts a recording device presence signal that identifies the device as capable of recording an audio and/or video signal and/or capturing a still image. To receive such a signal, the monitoring system 100 includes at least a receiver for that purpose.

The recording device presence signal broadcast by the recording device 200 of FIG. 2 to identify its presence to the monitoring device 100 can comprise an auditory signal, a visible light, an invisible light (e.g., infrared light), a radio-frequency signal, a wireless signal, and/or any combination of such signals. As a general rule, radio frequency or wireless signals likely will prove most versatile because auditory and visible light signals lie within the range of human perception and likely will not prove generally acceptable. Moreover, the transmission of auditory and light signals from the recording device 100 can cause high device high power consumption, as well cause interference, and “shadow” deficiencies as compared to transmitting radio-frequency and wireless signals.

In response to receipt of the recording device presence signal from the transmit-compliant recording device 200, the monitoring system 100 typically will generate a warning 400 to alert potential victims of the presence of the recording device within the monitored environment 300. The warning could take the form of an auditory signal, such as a single frequency tone modulated or not, a buzzer, a bell, or even a voice message, or a combination of such signals. Other auditory signals are also possible. Also, the warning could take the form of a visual signal, such as a light or image for example. Indeed, the warning could take other forms, e.g., an e-mail or a telephone call to potential victims within the monitored environment 300. The warning 400 could also take the form of a disruption to the monitored environment, such as but not limited to, the dimming of lights or the broadcast of recording device restriction signal that would interfere with the recording quality of the recording device.

Upon receipt of the recording device present signal from the transmit-compliant recording device 200, the monitoring system 100 of FIG. 2 could send an acknowledgement signal. Note that receipt of such an acknowledgement signal by the monitoring system 100 does not constitute an essential feature of the present principles. However, receipt of an acknowledgement at the transmit-compliant recording device 200 from the monitoring system 100 could constitute legal proof that the recording device sought to identify itself to comply with anti-voyeur policies in existence within the monitored environment 300.

FIG. 3 depicts a block schematic diagram of a monitoring system 100 in accordance with yet another aspect of the present principles. The monitoring system 100 of FIG. 3 includes a transmitter that broadcasts a recording device disable signal to all “disable-compliant” recording devices, such as recording device 200, in the monitored environment 300. For purposes of the embodiment of FIG. 3, a disable-compliant recording device comprises a recording device, which in response to recording device disable signal from the monitoring system 100, disables its recording functionality. Thus, for example, upon receipt of a recording device disable signal from the monitoring system 100, the recording device 200 will inhibit all recording.

The recording device disable signal from the monitoring system 100 of FIG. 3 could inhibit only certain kinds of recording. Depending on the sophistication of the recording device 200, the recording device disable signal could inhibit certain types of video recording and still image capture while permitting other types of such recording. For example, the recording device disable signal could restrict the video recording or still image capture of human figures while permitting the recording and/or still image capture of inanimate objects. The recording device 200 of FIG. 3 could employ pixel processing to differentiate between flesh colored objects (human beings) and other objects.

Furthermore, the recording device disable signal broadcast by the monitoring system 100 to the recording device 200 of FIG. 3 to inhibit recording could affect different recording capabilities. The recording device disable signal from the monitoring system 100 could remain valid for a pre-determined amount of time or for an amount of specified in the signal or until the voyeur decides to reactivate the recording functionality. Additionally, the recording device, upon receipt of such a disable signal, could display to the recording device user the particular type of recording restriction then in place.

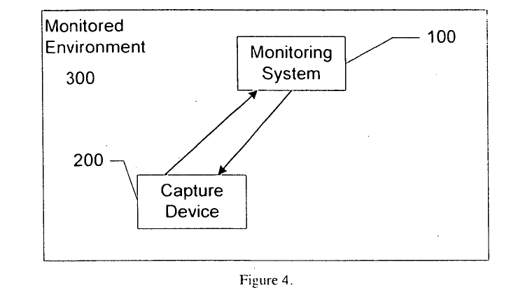

FIG. 4 depicts a block schematic of a monitoring system 100 in accordance with yet another aspect of the present principles. The monitoring system 100 of FIG. 4 includes a transceiver capable of receiving the recording device presence signal from a “duplex-compliant” recording device 200 indicating its presence. The term “duplex-compliant”, as used herein in connection with the recording device 200 of FIG. 4 describes a device that possess both the transmit-compliant and disable-compliant properties of the recording device 200 of FIGS. 2 and 3, respectively. In other words, the recording device 200 of FIG. 4 has the capability of both transmitting a recording device presence signal to identify itself, as well as the capability of receiving recording device disable signal causing the recording device to partially or completely disable its recording function.

In response to the recording device presence signal from the recording device 200, the monitoring system of FIG. 4 transmits the recording device disable signal to the recording device to disable recording. In this regard, the recording device 200 of FIG. 4 will disable recording in much the same way as the recording device 200 of FIG. 3. Under such circumstances, the recording device 200 could possess a mechanism (not shown) to indicate that its recording capability has temporally ceased. In addition, the response of the monitoring system 100 to the presence of the recording device 100 could trigger the generation by the monitoring system of a nuisance signal to degrade the quality of the recording in such a way that the victim's privacy remains unexposed.

The monitoring process described above with respect to FIGS. 1-4 depicts a single monitoring system 100 for monitoring the entire environment 300. Although not shown, the monitoring system 100 could easily comprise multiple elements (receivers) which operate collectively to geographically locate an active recording device within the monitored environment 300. In this way, the monitoring system 100 can localize its response to a specific recording device. Moreover, the monitoring system 100 of FIGS. 1-4 advantageously can possess the ability to geographically locate a recording device and target the response. In particular, the monitoring system 100 can use any one of a variety of well known techniques for locating a recording device, including triangulation for example.

Each of recording devices 200₁-200₄ of the present principles, in addition to being receive-compliant, transmit compliant, and/or duplex compliant, could also possess the ability to act as a repeater to relay a signal between monitoring system 100 and another device. Thus, for example, a recording device could relay a recording device restriction signal from the monitoring system 100 to another recording device. By the same token, a recording device also could relay a recording device presence signal from another recording device to the monitoring system.

The monitoring system 100 of FIGS. 1-4 will know the characteristics of the signals from the recording devices and vice versa. Indeed, to make the recording restriction method of the present principles widely adopted, the signal characteristics should become part of a standard, a government or semi-government regulation, or a government or semi-government legislation.

The monitoring techniques described with respect to FIGS. 1-4 can suffer from a “false positive,” i.e., a proper response to an illegitimate, corrupted, or non-existent signal. Such false positives can have certain consequences. For example, a false positive condition could trigger the disabling of recording of a recording device outside the monitored environment. Alternatively, a false positive could result in the announcement of the presence and/or or location, of a recording device previously turned off. Limiting the range of broadcast of signals by both the recording device and monitoring system will help reduce false positives. Also, localizing reception of signals from the recording device and monitoring system by using wireless signals in frequency bands with known range restrictions, such as Blue Tooth technology, will help as well. Providing the monitoring system with one or more receivers with narrower beam width to effectively cover only the inner bound of the monitored environment 300 will also help. The use of signal redundancy and error connection techniques can also reduce the likelihood of false positives. Any efforts to reduce false positives should not however significantly increase the risk of a false negative, i.e., an improper or non-existent response to a proper signal.

The foregoing describes a technique addressing the problem of unauthorized recording of a victim by an electronic voyeur.

1. A method comprising for communicating recording restrictions to at least one recording device comprising the step of broadcasting, within a defined environment, a recording device restriction signal for reception by the at least one recording device to alert the device of at least one recording restriction within the defined environment.

2. The method according to claim 1 wherein the recording device restriction signal comprises at least one of an auditory signal, a visible signal, a radio-frequency signal, and wireless signal.

3. The method according to claim 1 further comprising the step of broadcasting the recording device restriction signal with specific characteristics to indicate different recording restrictions.

4. The method according to claim 1 further including the step of receiving from the at least one recording device an acknowledgement of receipt of the recording device restriction signal.

5. A method for operating a recording device, comprising the steps of:
receiving within a defined environment, a recording device restriction signal to alert the device of at least one recording restriction within the defined environment; and
transmitting an acknowledgement signal to indicate receipt of the recording device restriction signal.

6. The method according to claim 5 wherein the recording device restriction signal comprises at least one of an auditory signal, a visible signal, a radio-frequency signal, and wireless signal.

7. The method according to claim 5 further comprising the step wherein the recording device restriction signal has different characteristics to indicate different recording restrictions.

8. The method according to claim 5 further including the step providing an indication at the recording device of receipt of the recording device restriction signal.

9. The method according to claim 5 further comprising the step of inhibiting the recording capability of the recording device upon receipt of the recording device restriction signal.

10. The method according to claim 9 further comprising the step of inhibiting different recording capabilities of the recording device based on different characteristics of the recording device restriction signal.

11. The method according to claim 10 further comprising the step of providing a display indicating of a type of recording capability restriction then in effect.

12. A method for detecting the presence of least one recording device in a monitored environment comprising the step of receiving from the at least one recording device a recording device presence signal that indicates the presence of a recording device having recording capabilities within the monitored environment.

13. The method according to claim 12 wherein the recording device presence signal comprises at least one of an auditory signal, a visible signal, a radio-frequency signal, and wireless signal.

14. The method according to claim 12 further comprising the step of transmitting an acknowledgement signal to the recording device upon receipt of the recording device presence signal.

15. The method according to claim 12 further comprising the step of broadcasting, within the monitored environment a recording device disable signal for receipt by the recording device to inhibit device recording.

16. The method according to claim 12 wherein the recording device disable signal comprises at least one of all auditory signal, a visible signal, a radio-frequency signal, and wireless signal.

17. The method according to claim 12 wherein the recording device disable signal has different characteristics to inhibit different types of recording.

18. The method according to claim 12 further comprising the step generating a warning upon detecting the presence of at least one recording device.

19. The method according to claim 18 wherein the warning comprises at least one of an auditory signal, a visual signal, an e-mail message, a telephone call, or a disruption created in the monitored environment.

20. A method for detecting the presence of a recording device and for disabling recording, comprising the steps of:
receiving a recording device presence signal from recording device upon the entry of the recording device in a monitored environment; and
broadcasting a recording device disable signal to at least partially inhibit recording by the recording device responsive to receipt of the recording device presence signal.

21. The method according to claim 20 further comprising the steps of:
locating the at least one recording device within the monitored environment; and
targeting the broadcasting of the recording device disable signal responsive to locating the recording device

22. The method according to claim 20 further including the step of relaying the recording device disable signal from the at least one recording device to another recording device.

23. A monitoring system for preventing unauthorized recording by a recording device comprising:
means for receiving a recording device presence signal from recording device upon the entry of the recording device in a monitored environment; and
mean is for broadcasting a recording device disable signal to at least partially inhibit recording by the recording device responsive to receipt of die recording device presence signal.

24. A recording device, comprising:
means for receiving within a defined environment, a recording device restriction signal to alert the device of at least one recording restriction within the defined environment; and
means for transmitting an acknowledgement signal to indicate receipt of the recording device restriction signal.
